(19) United States
(12) Patent Application Publication
(10) Pub. No.: US 2007/0028410 A1
(43) Pub. Date: Feb. 8, 2007

(54) Wiper device

(76) Inventors: Michael Weiler, Chungchongbuk-Do (KR); Arnold Ewald, Baden-Baden (DE)

Correspondence Address: MICHAEL BEST & FRIEDRICH, LLP, 100 E WISCONSIN AVENUE, MILWAUKEE, WI, 53202, US

(21) Appl. No.: 10/570,900

(22) PCT Filed: Jun. 2, 2004
(86) PCT No.: PCT/DE04/01120

§ 371 Date: Mar. 7, 2006

(30) Foreign Application Priority Data
Sep. 8, 2003 (DE) 10341280.8

(51) Int. Cl. B60S 1/36; B60S 1/06; B60S 1/34

(52) U.S. Cl. 15/250.23; 15/250.351; 15/250.21; 15/250.32

(57) ABSTRACT

The invention relates to a wiper device, in particular for a motor vehicle, comprising a wiper arm (12a, 12b) and a control unit (18a, 18b) for controlling the position (α) of a wiper blade (10a, 10b) in relation to the wiper arm (12a, 12b), in accordance with at least one operating variable (β), in particular of an operating position of the wiper arm (12a, 12b). It is proposed that the wiper arm (12a, 12b) has a freedom of movement (γ) achieved without articulation, which is capable of producing a contact force.

### BACKGROUND OF THE INVENTION

The invention starts with a wiper device.

A wiper device with a control unit having a wiper arm and a wiper blade fastened to the control unit is known from DE 100 10 393 A1. Designing the wiper arm as a parallel oscillating crank, which is connected to additional gear elements forming the control unit, is proposed. The control unit is supposed to control the position of the wiper blade in relation to the wiper arm in accordance with one operating position of the wiper arm, and namely in such a way that the surface being wiped by the wiper blade during a wiping movement approximates a rectangular shape to the greatest possible extent.

### SUMMARY OF THE INVENTION

The invention starts with a wiper device, in particular of a motor vehicle, comprising a wiper arm and a control unit for controlling the position of a wiper blade in relation to the wiper arm, in accordance with at least one operating variable, in particular of an operating position of the wiper arm. In this context, operating position should be understood as all positions, which could occur when the wiper device is in a mounted state.

It is proposed that the wiper arm have a freedom of movement achieved without articulation, which is capable of producing a contact force. As a result, it is possible to achieve a flat and narrow wiper device having a control unit and a freedom of movement achieved without articulation, which is capable of producing a contact force, which has advantageous aerodynamic properties. In particular, when used on windshields of motor vehicles, impairment of the motor vehicle driver's vision by the control unit and the increased wind resistance due to the control unit being opposite from the uncontrolled wiper devices can both be advantageously reduced at least to a large degree.

In this context, “freedom of movement achieved without articulation” should be understood as a movement being made possible without a materially executed swivel axis. Components that enable a relative movement between a wiper rod or partial areas of the wiper rod and a fastening part due to a material deformation, particularly due to an elastic deformation, should not be viewed as articulation in this context and should, in particular, also be included in the scope of protection, e.g., integral hinges, spring elastic partial pieces, leaf springs, spring elastic wiper rods, etc.

In addition, it is proposed that the control unit have a different mechanical connecting part to a body of a motor vehicle than the wiper arm. As a result, an operating position of the wiper arm in relation to a component connected rigidly to the body of the motor vehicle, in particular to a windshield of a motor vehicle, can be mechanically sensed advantageously and used as a parameter for controlling the position of the wiper blade. However, another, e.g., electromagnetic, sensor unit and/or control unit and an indirect sensing of the operating position of the wiper arm, e.g., via a component of a drive device of said wiper arm, is also conceivable.

In one embodiment of the invention, it is proposed that the connecting part be produced by a second wiper arm or that the connecting part can at least assume the essential functions of a wiper arm, in particular the generation of a contact force. The functions of the driving mechanism and the generation of the contact forces can be distributed to both wiper arms. In addition, both tensile force as well as compressive force can be transmitted advantageously via the connecting part. If the second wiper arm is in particular structurally equivalent to the first wiper arm, cost-effective production and comfortable assembly can be achieved.

If the control unit controls the position of the wiper blade in relation to the wiper arm in accordance with a position of a connecting part in relation to the wiper arm, a direct translation of this relative position into the position of the wiper blade can be achieved in a structurally simple and rugged manner. The connecting part can advantageously assume a sensor and control function at the same time.

If the wiper arm and the connecting part are arranged one on top of the other in a top view in at least one operating position and in at least one partial section of the wiper arm, an especially thin and flat wiper device, which is thin overall due to a flat design of the wiper arm and the connecting part, can be achieved advantageously, which only inconsequentially restricts the visual field of the motor vehicle driver in a motor vehicle in particular.

In addition, a rugged and directly effective control unit can be achieved if the wiper arm and the connecting part are connected on one free end of the wiper arm by a coupler, to which the wiper blade is essentially rigidly connected in a mounted state.

In another embodiment of the invention, it is proposed that the connecting part have at least one flexible partial area. In this context, a “flexible component” should be understood as a type of component via which essentially only tensile forces can be transmitted. In this context, particularly cables, chains, belts and wires, as they are used in particular in Bowden cables, should be viewed as flexible components. Flexible components can be designed with particularly small dimensions in directions perpendicular to a direction of a transmitted tensile force. As a result, a narrow design of the wiper device can be achieved advantageously, which integrates the control unit at least partially into the wiper arm in a space saving manner and, particularly when used in motor vehicles, an additional obstacle to the motor vehicle driver's visibility caused by the control unit can be avoided.

In another embodiment of the invention, it is proposed that the wiper arm have at least one area reinforced by at least one profile. As a result, the flexural strength of the wiper rod can be varied along its longitudinal extension and/or a desired flexural strength can be achieved with cost-effective production. With an appropriate selection of the shape of the profile, the reinforced area can be embodied as a spoiler, which generates a contact force as a function of the speed of the air stream and imparts the wiper arm with advantageous aerodynamic properties.

If the wiper arm can essentially be transferred spring elastically from a working configuration into a first stable configuration, in which the wiper blade can be mounted and dismounted, comfortable replacement of the wiper blade and cleaning of the windshield in the wiper arm's stable folded-out position can be enabled advantageously. This type of first stable configuration can be achieved structurally simply by integrating a bi-stable partial area into the wiper arm.

In addition, manufacturing tolerances can be equalized advantageously if the wiper arm has a device for adjusting the contact force.

In another embodiment of the invention, it is proposed that a wiper device feature a wiper arm with at least one leaf spring element for producing a contact force. Wiper arms with articulation that have a leaf spring element can be constructed to be very flat and can therefore be used advantageously in combination with a control unit for the position of the wiper blade.

The wiper device in accordance with the invention is basically suitable for all wiper systems for which they appear to be meaningful to the person skilled in the art, however especially advantageously for one-arm wiper systems.

### BRIEF DESCRIPTION OF THE DRAWINGS

Additional advantages are yielded from the following description of the drawings. Exemplary embodiments of the invention are depicted in the drawings. The drawings, the description and the claims contain numerous features in combination. The person skilled in the art will also observe individual features expediently and combine them into additional, meaningful combinations.

The drawings show:

FIG. 1 A schematic depiction of the functioning of a wiper device with a control unit for controlling the position of a wiper blade in relation to a wiper arm.

FIGS. 2 and 3 A top view and a side view of the wiper device from FIG. 1.

FIGS. 4 and 5 A diagonal view and a sectional representation of a coupler of the wiper device from FIGS. 1-3 with sections of the wiper arm and a connecting part.

FIG. 6 A section of the wiper device from FIGS. 1-5 with two fastening parts.

FIGS. 7 and 8 An alternative wiper device with a flexible partial area.

FIGS. 9-11 A section of a wiper arm for another alternative wiper device with a freedom of movement that can be achieved via articulation and a leaf spring.

### DETAILED DESCRIPTION

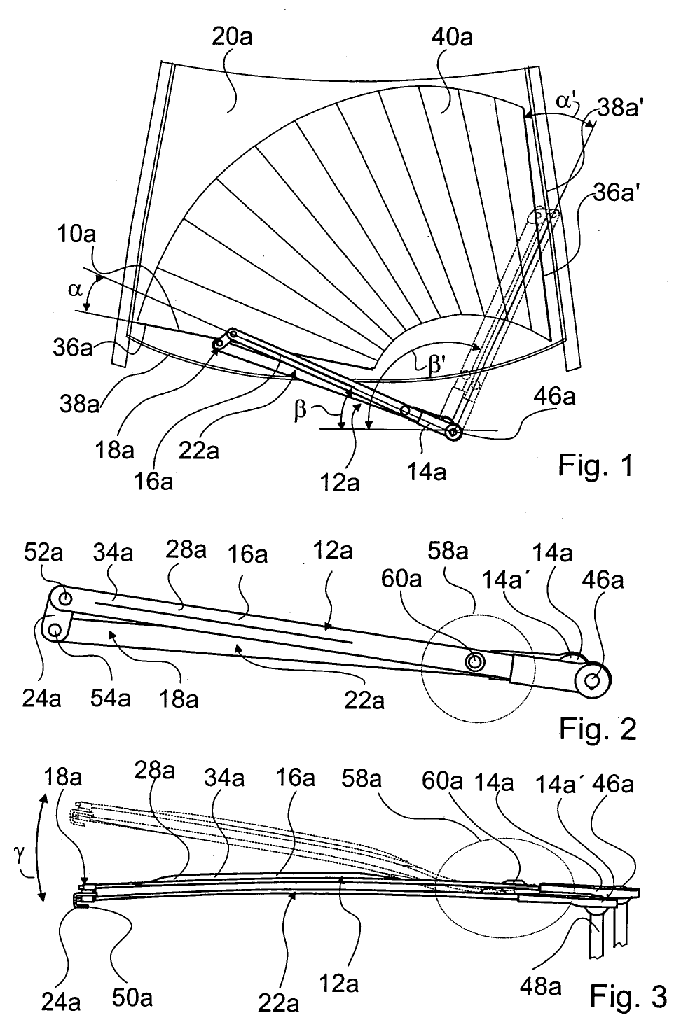

FIG. 1 shows a schematic depiction of the functioning of a one-arm wiper device for a windshield 20a of a motor vehicle with a control unit 18a for controlling a position α determined by an angle of a wiper blade 10a in relation to a wiper arm 12a in accordance with an operating variable β produced by an operating position of the wiper arm 12a. The wiper arm 12a has a fastening part 14a and a wiper rod 16a that is connected with this without articulation. The wiper rod 16a is formed by a leaf spring, whereby the wiper arm 12a has a freedom of movement γ achieved without articulation, which is capable of producing a contact force. By changing the position α of the wiper blade 10a in relation to the wiper arm 12a in accordance with the operating variable β of the wiper arm 12a, the wiper blade 10a runs in an upper reversing position 36a′ and a lower reversing position 36a each essentially parallel to an edge 38a, 38a′ of the windshield 20a, whereby at the same time a portion of the wiped surface 40a on the surface of the windshield 20a is enlarged as compared with a wiping movement with constant position α.

In addition to the wiper arm 12a, the wiper device has another mechanical connecting part 22a formed by a second wiper arm, and in a mounted state said connecting part is swivelably connected on a fastening-side end to a vehicle body (not shown) via an axis 48a and is structurally equivalent with the wiper arm 12a.

The wiper arm 12a is fastened on its fastening-side end to a drive shaft 46a and on its free end also carries along the connecting part 22a connected to it via a coupler 24a during the wiping movement.

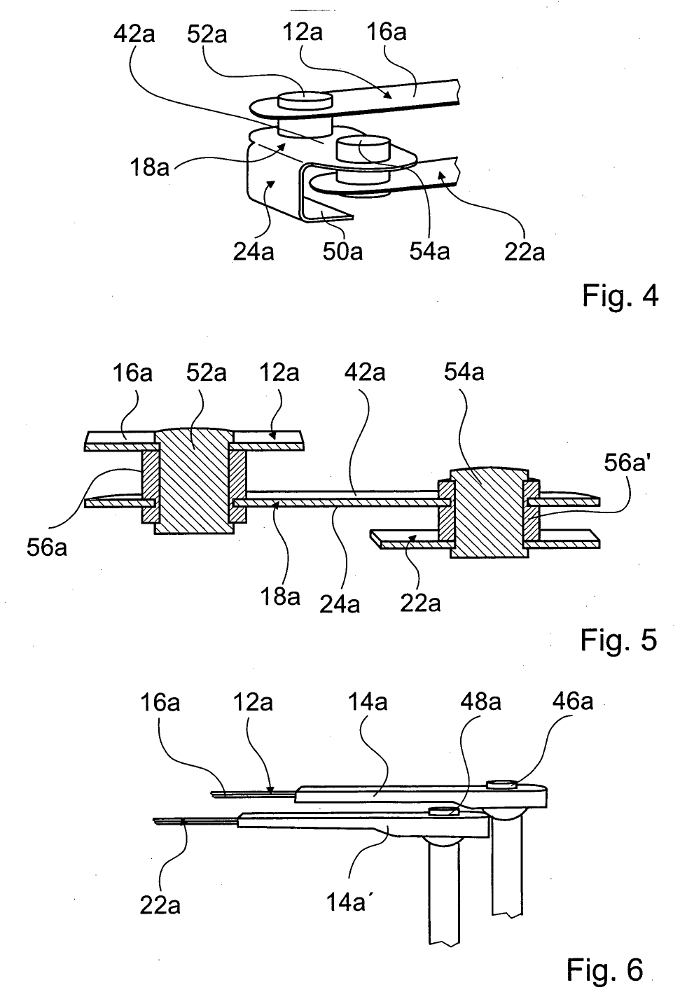

The coupler 24a has a connecting area 42a and an interface 50a, on which the wiper blade 10a can be fastened. The connecting area 42a is comprised of flat sheet metal with two holes, through which the coupler 24a is connected via two rivets 52a, 54a with a plastic sheathing 56a to the wiper arm 12a and the connecting part 22a (FIGS. 4 and 5). The rivets 52a, 54a form articulations so that the wiper arm 12a and the connecting part 22a essentially form a parallel crank with the coupler 24a, and said parallel crank represents a control unit 18a for controlling the position α of the wiper blade 10a in relation to the wiper arm 12a. A bracket embodied as a single piece with the connecting area 42a is bent into a hook via two 90° diversions. The wiper blade 10a can be clamped or screwed onto a lower area of the bracket parallel to the connecting area 42a that forms the interface 50a.

The relative position of the wiper arm 12a and the connecting part 22a is determined by the operating variable β, i.e., the operating position of the wiper arm 12a, and changes during a wiping movement. In this case, the wiper arm 12a and the connecting part 22a are arranged one on top of the other in the lower reversing position 36a and overlap one another in a top view (FIG. 2). In the upper reversing position 36a′, the wiper arm 12a and the connecting part 22a run essentially parallel in their longitudinal extension. As a result, the change of the relative position of the wiper arm 12a and the connecting part 22a is directly translated into a change of the position of the coupler 24a and thus the position a of the wiper blade 10a in relation to the wiper arm 12a. The functional form of this translation is determined by a selection of the lengths of the components 12a, 22a and 24a and the locations of the drive shaft 46a and the axis 48a.

In order to increase the flexural strength, the wiper arm 12a has an area 28a reinforced by a profile, and said area is embodied as a spoiler 34a. An air stream generates excess pressure on the upper side of the spoiler 34a and negative pressure on the lower side. The resulting force is supported on the windshield 20a and generates a contact force that is a function of the speed of the air stream.

The wiper arm 12a includes a bi-stable partial area 58a, which has a curved formation 60a. This allows the wiper arm 12a to be transferred essentially spring elastically via the freedom of movement γ achieved without articulation from a working configuration, in which the formation 60a extends in a direction facing away from the windshield 20a and opens towards the windshield 20a, via a reversing point, where the formation 60a upends suddenly, into a folded-out position indicated by a dashed line (FIG. 3), in which the formation 60a extends in a direction facing the windshield 20a and opens in a direction facing away from the windshield 20a. As a result, comfortable mounting and dismounting of the wiper blade 10a is made possible.

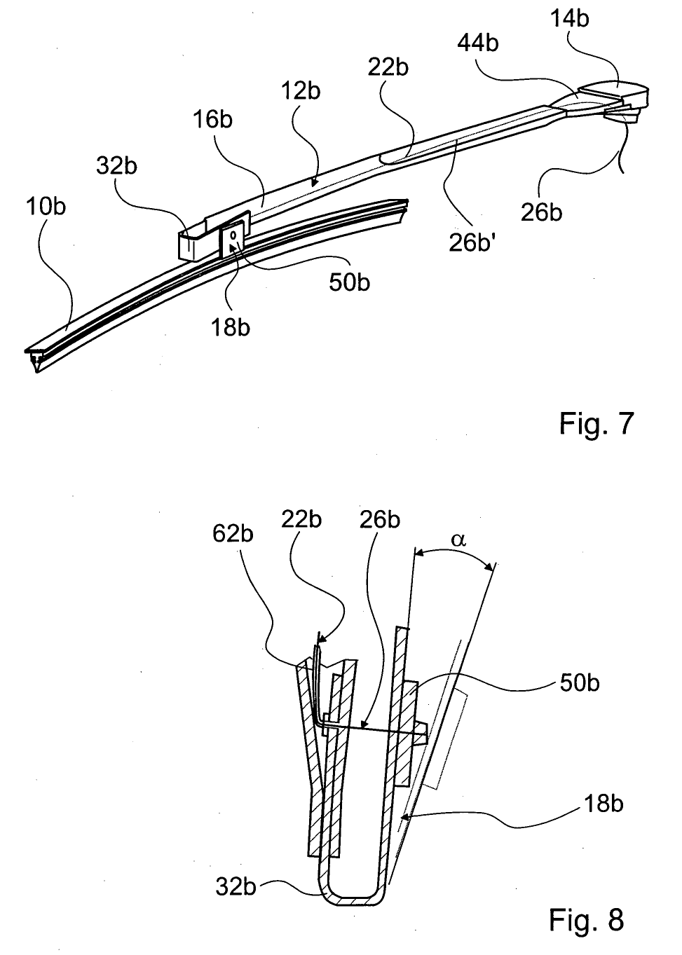

FIGS. 7 through 11 depict sections of components of alternative wiper devices. In the description of the exemplary embodiments essentially the same components and the same features are identified as a rule with the same reference numbers, whereby letters have been added to differentiate the exemplary embodiments. In addition, reference can be made to the description of the exemplary embodiments in FIGS. 1 through 6 with regard to the features and functions that remain the same. The following description is limited essentially to the differences from the exemplary embodiments in FIGS. 1 and 6.

In the case of an alternative wiper device, a connecting part 22b is realized by a flexible partial area 26b embodied as a wire pull that is guided into a casing 62b, and said partial area's first section 26b′ is guided into a interior space of a tubular wiper rod 16b and during mounting is connected on one free end 26b (FIG. 10) under initial stress to a vehicle body (not shown here).

The wiper rod 16b is connected without articulation to a fastening part 14b via a spring elastic partial area 44b and on its free end overlaps a first leg of a V-shaped leaf spring 32b in a force-free configuration. The connecting part 22b acts on a second, free leg of the leaf spring 32b, on which a wiper blade 10b is also fastened, and exerts a tensile force on said leg, which force is supported via the casing 62b on the first leg of the leaf spring 32b so that an opening ankle α′ of the leaf spring 32b diminishes with increasing tensile force and thereby changes the position a of the wiper blade 10b vis-à-vis the wiper rod 16b (FIG. 8). In principle, the tensile force can be initiated via the connecting part 22b as a function of any operating variable. However, if the connecting part 22b is rigidly connected to a vehicle body (not shown here), a force can be initiated, in particular via a roll surface for the connecting part 22b, and said force can be used to control the position a of the wiper blade 10b, which is determined directly by an operating variable β produced by an operating position of the wiper arm 12b.

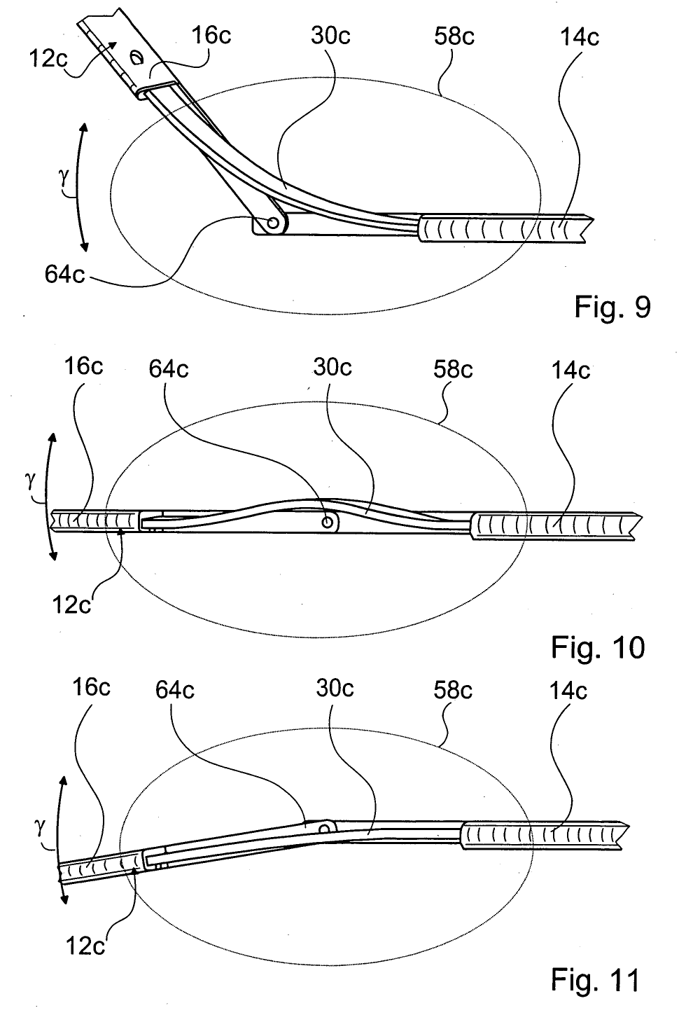

FIGS. 9 through 11 depict a bi-stable partial area 58c of another alternative wiper device with a leaf spring element 30c, an articulation 64c and a control unit (not shown here) for controlling the position of a wiper blade in relation to a wiper arm 12c. The bi-stable partial area 58c serves as a fold-out device, replaces the bi-stable partial area 58a (FIGS. 1 through 3) and can be transferred via an upending of a curvature of the leaf spring element 30c from a working configuration (FIG. 10), in which the leaf spring element 30c generates a contact force, to a first stable configuration (FIG. 9), in which comfortable mounting and dismounting of a wiper blade is possible. FIG. 11 shows a second, stable configuration representing a delivery position.

1. Wiper device, in particular for a motor vehicle, comprising a wiper arm (12a, 12b) and a control unit (18a, 18b) for controlling the position (α) of a wiper blade (10a, 10b) in relation to the wiper arm (12a, 12b), in accordance with at least one operating variable (β), in particular of an operating position of the wiper arm (12a, 12b), characterized in that the wiper arm (12a, 12b) has a freedom of movement (γ) achieved without articulation, which is capable of producing a contact force.

2. Wiper device according to claim 1, characterized in that the control unit (18a, 18b) features a different mechanical connecting part (22a, 22b) to a body of a motor vehicle than the wiper arm (12a, 12b).

3. Wiper device according to claim 2, characterized in that the connecting part (22a, 22b) is produced by a second wiper arm.

4. Wiper device according to claim 2, characterized in that the control unit (18a, 18b) controls the position (α) of the wiper blade (10a, 10b) in accordance with a position of a connecting part (22a, 22b) in relation to the wiper arm (12a, 12b).

5. Wiper device according to claim 2, characterized in that the wiper arm (12a, 12b) and the connecting part (22a, 22b) are arranged one on top of the other in a top view in at least one operating position and in at least one partial section of the wiper arm (12a, 12b).

6. Wiper device according to claim 2, characterized in that the wiper arm (12a) and the connecting part (22a) are connected on one free end of the wiper arm (12a) by a coupler (24a), to which the wiper blade (10a) is essentially rigidly connected in a mounted state.

7. Wiper device according to claim 2, characterized in that the connecting part (22b) has at least one flexible partial area (26b).

8. Wiper device according to claim 1, characterized in that the wiper arm (12a) has at least one area (28a) reinforced by at least one profile.

9. Wiper device according to claim 8, characterized in that the reinforced area (28a) is embodied as a spoiler (34a).

10. Wiper device, in particular for a motor vehicle, comprising a wiper arm (12c) and a control unit for controlling the position of a wiper blade in relation to the wiper arm (12c), in accordance with at least one operating variable, in particular the position of the wiper arm (12c), characterized in that the wiper arm (12c) has at least one leaf spring element (30c) for producing a contact force.
